(19) United States
(12) Patent Application Publication
(10) Pub. No.: US 2009/0271710 A1
(43) Pub. Date: Oct. 29, 2009

(54) Remote On-Screen Display Control

(75) Inventors: Dan Montz, Beaverton, OR (US); Randy Nash, McMinnville, OR (US); Kurt Fankhauser, Sherwood, OR (US)

Correspondence Address: ALLEMAN HALL MCCOY RUSSELL & TUTTLE LLP, 806 SW BROADWAY, SUITE 600, PORTLAND, OR, 97205-3335, US

(73) Assignee: INFOCUS CORPORATION, Wilsonville, OR (US)

(21) Appl. No.: 12/108,042

(22) Filed: Apr. 23, 2008

(51) Int. Cl. G06F 3/00

(52) U.S. Cl. 715/740

(57) ABSTRACT

A remote control of an on-screen display is provided. One example embodiment includes a method for receiving a first command from a user input device and converting the first command from the user input device to a second command, wherein the second command is in a display device format that the display device can use to control an on-screen display, then sending the second command to the display device to remotely control an on-screen display in the display device.

### TECHNICAL FIELD

The present disclosure relates to systems, apparatus and methods for a remote on-screen display control for a display device.

### BACKGROUND

Information display devices, also referred to herein as image devices or display devices, may be used in a variety of environments. Example information display devices include, but are not limited to, televisions, monitors, and projectors. The following is a non-exhaustive list of exemplary display devices: cathode ray tubes (CRTs), flat panel liquid crystal display systems, LED systems, plasma systems, front projection systems, rear projection systems, LCD monitors, etc.

Information display devices may be adapted to display images, including text, graphics, video images, still images, presentations, etc. Such display devices may be found in home environments and applications, education environments and applications, business facilities, conference rooms and other meeting facilities, etc.

Images or content displayed on the display devices may be provided by one or more of a plurality of different content sources. Example content sources include, but are not limited to, computing devices, storage mediums such as memory cards and other memory devices, cameras, telephones, portable data assistants, media players, etc.

Image data from the content source may be transmitted to the display device directly or through a network. The content source may be connected, e.g. wired or wirelessly, to the display device for transmission of content to the display device.

Content sources may adjust the images or content to be displayed on the display device using user inputs. However, display device settings are adjusted by buttons in the display device or by a separate physical remote control for the display device. This can result in multiple controls, such as for a common task, and can complicate operation of display devices.

### SUMMARY

Accordingly, various embodiments for remote control of an on-screen display in a display device with user inputs to a computing device are described below in the Detailed Description. For example, one example embodiment includes a method for receiving a first command from a user input device and converting the first command from the user input device to a second command, wherein the second command is in a display device format that the display device can use to control an on-screen display, then sending the second command to the display device to remotely control an on-screen display in the display device.

This Summary is provided to introduce concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE FIGURES

FIG. 1 shows a schematic depiction of an exemplary embodiment of a remote on-screen display control for a device according to the present disclosure.

FIG. 2 shows a flow diagram of an exemplary method for remote control of an on-screen display in a display device with a computing device according to the present disclosure.

FIG. 3 shows a mapping table including exemplary keyboard command conversions to on-screen display projector commands.

FIG. 4 shows a mapping table including exemplary mouse command conversions to on-screen display projector commands.

FIG. 5 shows a schematic depiction of a mouse cursor sensitivity algorithm to provide hysteresis.

FIG. 6 shows a schematic depiction of a mouse cursor sensitivity algorithm to provide hysteresis.

### DETAILED DESCRIPTION

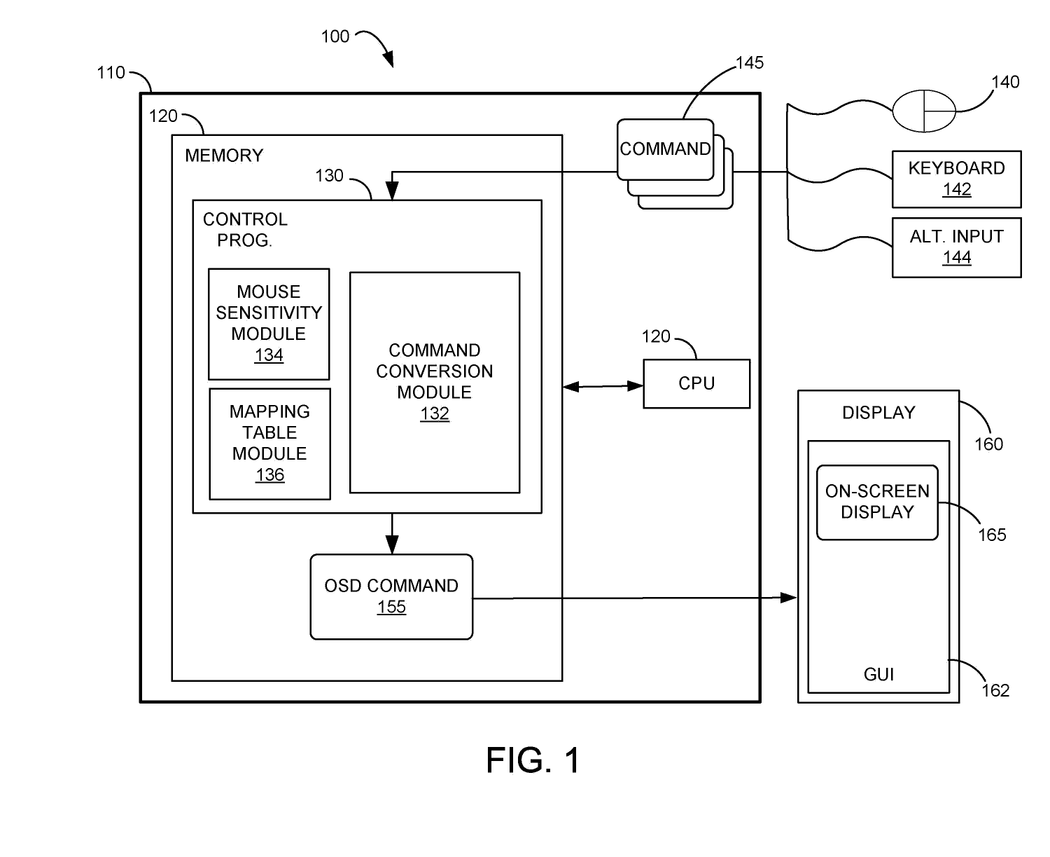

FIG. 1 shows a schematic depiction of system 100 including an exemplary embodiment computing device 110 for remote on-screen display control for a display device 160 according to the present disclosure. In some embodiments, display device 160 may be a projector, a television, a monitor, or other suitable display device with on-screen display functionality. Computing device 110 typically comprises a memory 120 and a central processing unit, or CPU 120. Memory 120 may comprise a control program 130 including a command conversion module 132 to receive commands from user input devices such as mouse 140, keyboard 142, alternate input device 144, or other user input devices. The input devices depicted in system 100 provide input commands that are in a specific format for computing device 110 and not other devices attached to computing device 110. Command conversion module 132 receives at least one of these input commands and converts it to an on-screen display command 155 in a format connected display 160 can use. Display 160 may be connected by a universal serial bus (USB) connection, a serial connection, an Ethernet connection, or other suitable peripheral connection architectures.

In some embodiments, display 160 may include a graphical user interface, or GUI 162 which includes an on-screen display 165 to adjust functionality of display 160. Display 160 typically has an interface on the display (not show) to adjust on-screen display 165 settings and in some cases display 160 may include a dedicated remote control device to wirelessly communicate with display 160, wherein the remote control device has a similar interface to the interface on the display 160 to in turn operate the on-screen display 165 over the wireless connection. However, a dedicated remote control for display device 160 may be cumbersome as a user would have to operate a computing device 110 as a content source as well as operate the dedicated remote control to adjust on-screen display 165 settings and display 160 settings.

In one embodiment, an image display system may include a personal computer as the computing device 110, wherein the personal computer is operable to receive a command 145 from a mouse 140, a keyboard 142, or an alternate input device 144, and the personal computer may include a control program 130 and with a command conversion module 132 that is operable to convert a first command 145 from the mouse 140, etc., to a menu state command or a menu control command that is recognizable by display 160. In this way, a computing device 110 can output the menu state command or the menu control command to a display device to remotely control an on-screen display 165 in the display device 160. Other embodiment may convert input commands to various other commands operable to control the built in interface for a display device.

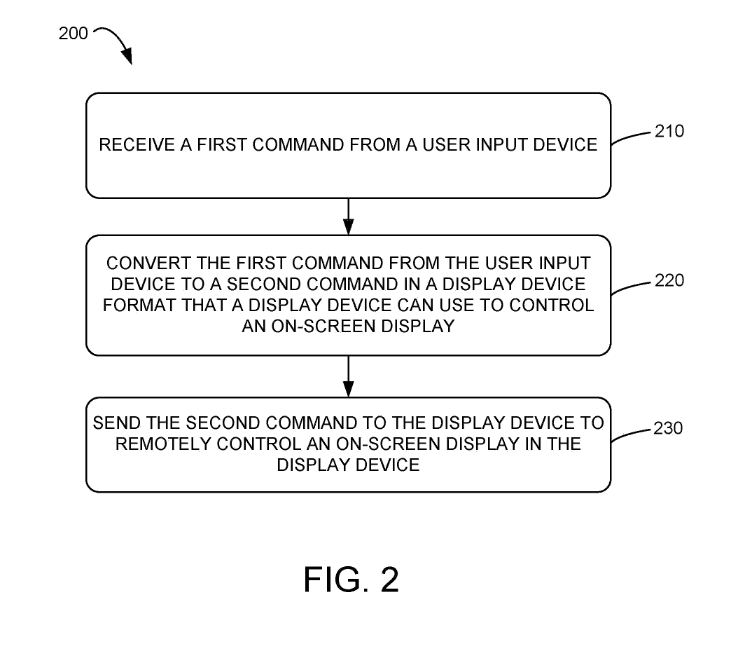

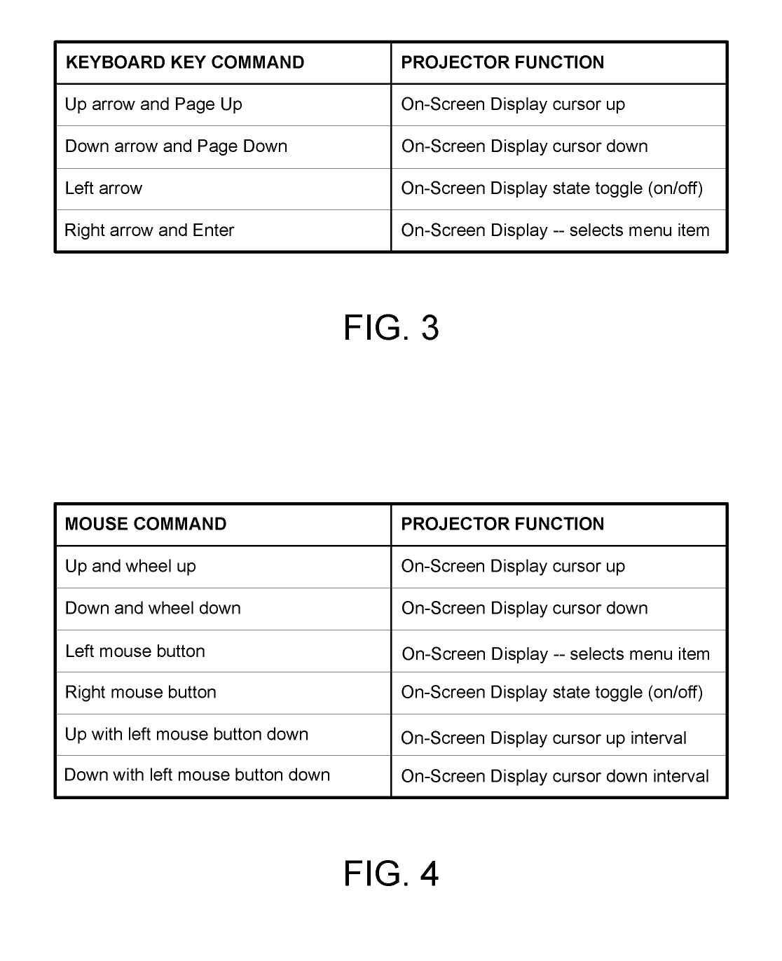

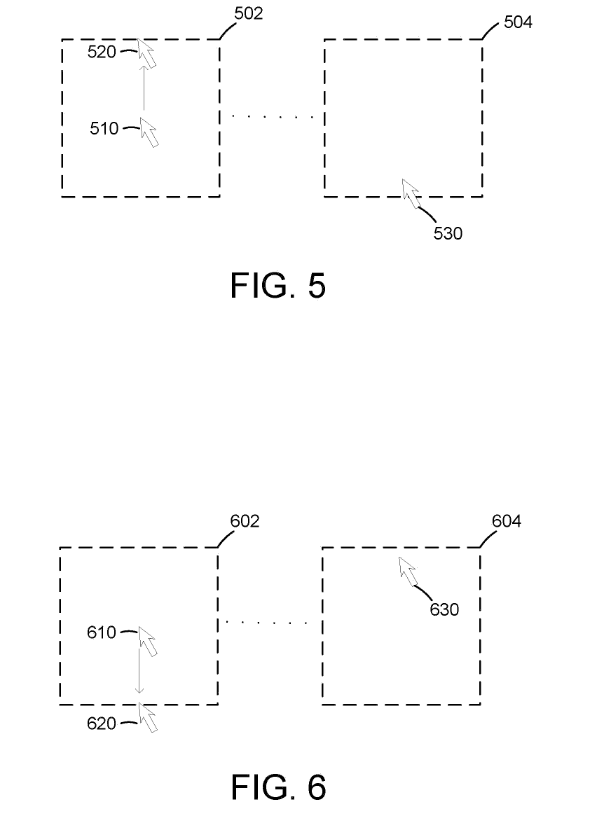

In some embodiments, computing device 110 may include a mapping table module 136 in control program 130 to map specific input commands from mouse 140, keyboard 142, or alternate input device 144 to on-screen display 165 commands as illustrated in the examples described in reference to FIGS. 3-4. In some embodiments, computing device 110 may include a mouse sensitivity module 134 in control program 130, wherein input commands can be adjusted to control the sensitivity of input commands in controlling the on-screen display 165 of display 160 in the examples described in reference to FIGS. 5-6. We now turn to FIG. 2 to describe embodiment methods that may be practiced with computing device 110.

FIG. 2 shows a flow diagram of an exemplary method 200 for remote control of an on-screen display in a display device using a computing device according to the present disclosure. In block 210, a computing device receives a first command from a user input device. User input device may be a mouse 140, a keyboard 142, or an alternate input device 144. The first command is typically in a format not recognizable by a display device directly but that is used in a computing device to manipulate programs running on the computing device. In block 220, the method converts the first command from the user input device to a second command in a display device format that a display device can use to control an on-screen display. In some embodiments, the first command from the user input device may be converted to at least one of a menu state command or a menu control command of the on-screen display, as non-limiting examples. Next, method 200 sends the second command to the display device to remotely control the on-screen display in the display device in response to a command from the user input device.

In some embodiments, the user input device may be a mouse wherein the first command is at least one of a left mouse button, a right mouse button, a mouse movement, or a scroll wheel command, etc., and these commands may be converted or mapped to specific on-screen display commands. In one example, mapping table module 136 as described in reference to FIG. 1 may provide conversion or mapping functionality. As an example, in reference to FIG. 4, a mouse up movement or a scroll wheel up command from the mouse may be converted to an on-screen display cursor up movement. In some embodiments, a mouse down movement or a scroll wheel down command may be converted to an on-screen display cursor down movement and a left mouse button command may be converted to an on-screen display select command to select a particular menu item in the on-screen display. Similarly, a right mouse button command may be converted to an on-screen display state toggle command, etc.

In some embodiments, the user input device may be a keyboard. As an example and in reference to FIG. 3, the first command may be a left arrow, right arrow, up arrow, a down arrow a page up, a page down or an enter command, and these commands may be converted or mapped to specific on-screen display commands. In one example, mapping table module 136 as described in reference to FIG. 1 may provide conversion or mapping functionality. For example, an up arrow or a page up command may be converted to an on-screen display cursor up movement and a down arrow or a page down command may be converted to an on-screen display cursor down movement. In another embodiment, a left arrow command may be converted to an on-screen display state toggle command. Additionally, a right arrow or an enter command may be converted to an on-screen display select command. Other embodiments may associate other keyboard commands with on-screen display commands within the principles of this disclosure.

FIG. 5 shows a schematic depiction of a mouse cursor sensitivity algorithm to provide hysteresis. In the illustrated example, method 200 or computing device 110 may provide functionality to position a mouse cursor 110 within a bounded area 502 on a display in communication with the computing device and detect a mouse up movement when the mouse cursor touches the top of the bounded area as illustrated with mouse cursor 520. In response to this detection, method 200 or computing device 110 may send an on-screen display cursor up command to a display device. Next, in bounded area 504, the mouse cursor 530 may be positioned a set distance from the bottom of the bounded area 502 to provide hysteresis to control mouse sensitivity. In this way, the computing device can provide an improved user experience by providing a corrected sensitivity when controlling the on-screen display of a display device.

In some embodiments, a combination of commands may be used to represent either a single on-screen display command, a sequence of on-screen display commands, etc. For example, a combination of a mouse up movement and a left mouse button command may be converted to an on-screen display cursor up command. In this way, while the left mouse up is held down, an on-screen display cursor down command may be sent to the display device multiple times. Other embodiments may use alternate combinations of inputs from input devices. In some embodiments, an interval between each of the multiple times an on-screen display command is sent may be adjusted to improve user experience, for example to provide hysteresis to provide an improved level of sensitivity when controlling an on-screen display of a display device.

FIG. 6 shows a schematic depiction of a mouse cursor sensitivity algorithm to provide hysteresis. In the illustrated example, method 200 or computing device 110 may provide functionality to position a mouse cursor 110 within a bounded area 602 on a display in communication with the computing device and detect a mouse down movement when the mouse cursor touches the top of the bounded area as illustrated with mouse cursor 620. In response to this detection, method 200 or computing device 110 may send an on-screen display cursor down command to a display device. Next, in bounded area 604, the mouse cursor 630 may be positioned a set distance from the top of the bounded area 604 to provide hysteresis to control mouse sensitivity. In this way, the computing device can provide an improved user experience by providing a corrected sensitivity when controlling the on-screen display of a display device.

Similar to the example described with reference to FIG. 5, in some embodiments a combination of commands may be used to represent either a single on-screen display command, a sequence of on-screen display commands, etc. For example, a combination of a mouse down movement and a left mouse button command may be converted to an on-screen display cursor down command. In this way, while the left mouse button is held down, an on-screen display cursor down command may be sent to the display device multiple times. In some embodiments, an interval between each of the multiple times an on-screen display command is sent may be adjusted to improve user experience, for example to provide hysteresis to provide an improved level of sensitivity when controlling an on-screen display of a display device. Other embodiments may use alternate combinations of inputs from input devices.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein.

Inventions embodied in various combinations and subcombinations of features, functions, elements, and/or properties may be claimed in a related application. Such claims, whether they are directed to a different invention or directed to the same invention, whether different, broader, narrower or equal in scope to any original claims, are also regarded as included within the subject matter of the inventions of the present disclosure.

What is claimed is:

1. In a computing device, a method for remote control of an on-screen display, the method comprising:
receiving a first command from a user input device;
converting the first command from the user input device to a second command, wherein the second command is in a display device format that the display device can use to control an on-screen display; and
sending the second command to the display device to remotely control an on-screen display in the display device.

2. The method of claim 1, wherein converting the first command from the user input device to a second command includes converting the second command to at least one of a menu state command or a menu control command.

3. The method of claim 1, wherein the user input device is a mouse and the first command is at least one of a left mouse button, a right mouse button, a mouse movement, or a scroll wheel command.

4. The method of claim 3, wherein converting the first command from the user input device to a second command further comprises converting a mouse up movement or a scroll wheel up command to an on-screen display cursor up movement, converting a mouse down movement or a scroll wheel down command to an on-screen display cursor down movement, converting a left mouse button command to an on-screen display select command, or converting a right mouse button command to an on-screen display state toggle command.

5. The method of claim 3, further comprising:
positioning a mouse cursor within a bounded area on a display in communication with the computing device;
detecting a mouse up movement when the mouse cursor touches the top of the bounded area;
sending an on-screen display cursor up command to a display device; and
positioning the mouse cursor a set distance from the bottom of the bounded area to provide hysteresis to control mouse sensitivity.

6. The method of claim 3, further comprising:
positioning a mouse cursor within a bounded area on a display in communication with the computing device;
detecting a mouse down movement when the mouse cursor touches the bottom of the bounded area;
sending an on-screen display cursor down command to a display device; and
positioning the mouse cursor a set distance from the top of the bounded area to provide hysteresis to control mouse sensitivity.

7. The method of claim 3, further comprising:
converting the first command from the user input device to a second command further comprises converting a combination of a mouse down movement and a left mouse button command to an on-screen display cursor down command; and
sending the on-screen display cursor down command to the display device multiple times according to a set interval.

8. The method of claim 3, further comprising:
converting the first command from the user input device to a second command further comprises converting a combination of a mouse up movement and a left mouse button command to an on-screen display cursor up command; and
sending the on-screen display cursor up command to the display device multiple times according to a set interval.

9. The method of claim 1, wherein the user input device is a keyboard and the first command is a left arrow, right arrow, up arrow, a down arrow a page up, a page down or an enter command.

10. The method of claim 9, wherein converting the first command from the user input device to a second command further comprises converting an up arrow or a page up command to an on-screen display cursor up movement, converting a down arrow or a page down command to an on-screen display cursor down movement, converting a left arrow command to an on-screen display state toggle command, and converting a right arrow or an enter command to an on-screen display select command.

11. A computer-readable medium comprising instructions executable by a computing device to remotely control an on-screen display in a display device with user inputs to a computing device, the instructions being executable to perform a method comprising:
receiving a first command from a user input device;
converting the first command from the user input device to a second command, wherein the second command is in a display device format that the display device can use to control an on-screen display; and
sending the second command to the display device to remotely control an on-screen display in the display device.

12. The computer-readable medium of claim 11, wherein converting the first command from the user input device to a second command includes converting the second command to at least one of a menu state command or a menu control command.

13. The computer-readable medium of claim 11, wherein the user input device is a mouse and the first command is at least one of a left mouse button, a right mouse button, a mouse movement, or a scroll wheel command.

14. The computer-readable medium of claim 13, wherein converting the first command from the user input device to a second command further comprises converting a mouse up movement or a scroll wheel up command to an on-screen display cursor up movement, converting a mouse down movement or a scroll wheel down command to an on-screen display cursor down movement, converting a left mouse button command to an on-screen display select command, or converting a right mouse button command to an on-screen display state toggle command.

15. The computer-readable medium of claim 13, further comprising instructions for:
positioning a mouse cursor within a bounded area on a display in communication with the computing device;
detecting a mouse up movement when the mouse cursor touches the top of the bounded area;
sending an on-screen display cursor up command to a display device; and
positioning the mouse cursor a set distance from the bottom of the bounded area to provide hysteresis to control mouse sensitivity.

16. The computer-readable medium of claim 13, further comprising instructions for:
positioning a mouse cursor within a bounded area on a display in communication with the computing device;
detecting a mouse down movement when the mouse cursor touches the bottom of the bounded area;
sending an on-screen display cursor down command to a display device; and
positioning the mouse cursor a set distance from the top of the bounded area to provide hysteresis to control mouse sensitivity.

17. The computer-readable medium of claim 13, further comprising instructions for:
converting the first command from the user input device to a second command further comprises converting a combination of a mouse down movement and a left mouse button command to an on-screen display cursor down command; and
sending the on-screen display cursor down command to the display device multiple times according to a set interval.

18. The computer-readable medium of claim 13, further comprising instructions for:
converting the first command from the user input device to a second command further comprises converting a combination of a mouse up movement and a left mouse button command to an on-screen display cursor up command; and
sending the on-screen display cursor up command to the display device multiple times according to a set interval.

19. The computer-readable medium of claim 11, wherein the user input device is a keyboard and the first command is a left arrow, right arrow, up arrow, a down arrow a page up, a page down or an enter command.

20. The computer-readable medium of claim 19, wherein converting the first command from the user input device to a second command further comprises converting an up arrow or a page up command to an on-screen display cursor up movement, converting a down arrow or a page down command to an on-screen display cursor down movement, converting a left arrow command to an on-screen display state toggle command, and converting a right arrow or an enter command to an on-screen display select command.

21. An image display system, comprising:
at least one of a mouse or a keyboard coupled with a computing device comprising a processor and a memory, the computing device operable to convert an first command from the mouse or the keyboard to a menu state command or a menu control command, the computing device operable to output the menu state command or the menu control command to a display device to remotely control an on-screen display in the display device; and
a display device coupled with the computing device, the display device to receive menu state command or the menu control command and to control an on-screen display in the display device in response to the menu state command or the menu control command.
